(19) United States
(12) Patent Application Publication
(10) Pub. No.: US 2010/0185757 A1
(43) Pub. Date: Jul. 22, 2010

(54) Method and Apparatus for Use in a Communications Network

(76) Inventors: Christer Boberg, Tungelsta (SE); Henrik Albertsson, Stockholm (SE); Anders Lindgren, Alvsjo (SE); Hans Åke Lindgren, Alvsjo (SE); Jan Holm, Gavle (SE)

Correspondence Address: ERICSSON INC., 6300 LEGACY DRIVE, M/S EVR 1-C-11, PLANO, TX, 75024, US

(21) Appl. No.: 12/593,683

(22) PCT Filed: Mar. 29, 2007
(86) PCT No.: PCT/EP2007/053042

§ 371 Date: Mar. 19, 2010

(51) Int. Cl. G06F 15/173

(52) U.S. Cl. 709/223

(57) ABSTRACT

A method is disclosed for use in a telecommunications network that makes use of the Session Initiation Protocol (SIP). The method comprises receiving node status information in a SIP Request whose Request Uniform Resource Identifier, or Request-URI, identifies the SIP Request as comprising node status information and also identifies the intended recipients of the node status information.

### TECHNICAL FIELD

The present invention relates to a method and apparatus for use in a communications network, for example a Universal Mobile Telecommunications System having an IP Multimedia Subsystem.

### BACKGROUND

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The UMTS (Universal Mobile Telecommunications System) is a third generation wireless system designed to provide higher data rates and enhanced services to subscribers. UMTS is a successor to the Global System for Mobile Communications (GSM), with an important evolutionary step between GSM and UMTS being the General Packet Radio Service (GPRS). GPRS introduces packet switching into the GSM core network and allows direct access to packet data networks (PDNs). This enables high-data rate packets switch transmissions well beyond the 64 kbps limit of ISDN through the GSM call network, which is a necessity for UMTS data transmission rates of up to 2 Mbps. UMTS is standardised by the 3^{rd} Generation Partnership Project (3GPP) which is a conglomeration of regional standards bodies such as the European Telecommunication Standards Institute (ETSI), the Association of Radio Industry Businesses (ARIB) and others. See 3GPP TS 23.002 for more details. The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

Specific details of the operation of the UMTS communications network and of the various components within such a network can be found from the Technical Specifications for UMTS that are available from http://www.3gpp.org. Further details of the use of SIP within UMTS can be found from the 3GPP Technical Specification TS 24.228 V5.8.0 (2004-03).

FIG. 1 of the accompanying drawings illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF.

A user registers with the IMS using the specified SIP REGISTER method. This is a mechanism for attaching to the IMS and announcing to the IMS the address at which a SIP user identity can be reached. In 3GPP, when a SIP terminal performs a registration, the IMS authenticates the user, and allocates an S-CSCF to that user from the set of available S-CSCFs. Whilst the criteria for allocating S-CSCFs is not specified by 3GPP, these may include load sharing and service requirements. It is noted that the allocation of an S-CSCF is key to controlling (and charging for) user access to IMS-based services. Operators may provide a mechanism for preventing direct user-to-user SIP sessions which would otherwise bypass the S-CSCF.

During the registration process, it is the responsibility of the I-CSCF to select an S-CSCF if an S-CSCF is not already selected. The I-CSCF receives the required S-CSCF capabilities from the home network's Home Subscriber Server (HSS), and selects an appropriate S-CSCF based on the received capabilities. [It is noted that S-CSCF allocation is also carried out for a user by the I-CSCF in the case where the user is called by another party, and the user is not currently allocated an S-CSCF.] When a registered user subsequently sends a session request to the IMS, the P-CSCF is able to forward the request to the selected S-CSCF based on information received from the S-CSCF during the registration process.

Within the IMS service network, Application Servers (ASs) are provided for implementing IMS service functionality. Application Servers provide services to end-users in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment. Different IFCs may be applied to different call cases. The IFCs are received by the S-CSCF from an HSS during the IMS registration procedure as part of a user's User Profile. Certain Application Servers will perform actions dependent upon subscriber identities (either the called or calling subscriber, whichever is “owned” by the network controlling the Application Server). For example, in the case of call forwarding, the appropriate (terminating) application server will determine the new terminating party to which a call to a given subscriber will be forwarded. In the case that an IFC indicates that a SIP message received at the S-CSCF should be forwarded to a particular SIP AS, that AS is added into the message path. Once the SIP message is returned by the AS to the S-CSCF, it is forwarded on towards its final destination, or forwarded to another AS if this is indicated in the IFCs.

There is a high demand on availability for services provided in telecommunications networks. In order to provide the required level of availability, several mechanisms are implemented in the network nodes, as well designed for in the network architecture.

One of the mechanisms required is the ability for a node to be informed of other nodes' availability, as well as whether some of those have been restarted.

This kind of functionality is often part of a bigger “restoration procedure” that also covers the action taken when a node is down, as well as when a node comes back into operation.

The current IMS implementation and standard (3GPP) lack a mechanism for restoration procedures, and hence also a mechanism for detecting the ability of nodes to handle already established SIP traffic (existing SIP sessions) is not provided for.

One possibility would be to use O&M (Operation and Maintenance) mechanisms; however that is likely to be a proprietary solution, with drawbacks of inflexibility.

It is desirable to address the above-identified issues.

### SUMMARY

According to a first aspect of the present invention there is provided a method for use in a telecommunications network that makes use of the Session Initiation Protocol, SIP, the method comprising receiving node status information in a SIP Request whose Request Uniform Resource Identifier, or Request-URI, identifies the SIP Request as comprising node status information and also identifies the intended recipients of the node status information.

The method may comprise determining the intended recipients from the received Request URI.

The method may comprise forwarding the status information to the determined recipients.

The method may comprise using the status information at the receiving node if the receiving node is determined to be one of the intended recipients.

The method may comprise referring to an Initial Filter Criteria associated with the Request URI to determine the intended recipients.

The method may comprise referring to a Dynamic Name Server to determine the intended recipients from the Request URI.

The method may comprise determining the intended recipients in dependence upon a previously-received SIP SUBSCRIBE Request.

The SIP Request may be a SIP PUBLISH Request.

The method may comprise using the time to live information from the SIP PUBLISH Request to infer further information about the node status

The SIP Request may be a SIP MESSAGE request.

The method may comprise storing the node status relating to those nodes identified by the SIP Request URI.

The network may be a Universal Mobile Telecommunications System comprising an IP Multimedia Subsystem, IMS.

According to a second aspect of the present invention there is provided a method for use in a telecommunications network that makes use of the Session Initiation Protocol, SIP, the method comprising sending node status information in a SIP Request whose Request Uniform Resource Identifier, or Request-URI, identifies the SIP Request as comprising node status information and also identifies the intended recipients of the node status information.

According to a third aspect of the present invention there is provided a method for use in a telecommunications network that makes use of the Session Initiation Protocol, SIP, the method comprising sharing a Node Status SIP URI amongst a group of nodes, the Node Status SIP URI being for use subsequently by a node of the group as the Request-URI in a SIP Request when sending node status information to other nodes in the group.

According to a fourth aspect of the present invention there is provided a use of a Session Initiation Protocol Request Uniform Resource Identifier, or SIP Request-URI, in a telecommunications network to identify the SIP Request as comprising node status information and/or to identify the intended recipients of the node status information.

According to a fifth aspect of the present invention there is provided an apparatus for use in a telecommunications network, the apparatus comprising means for performing a method according to any one of the first to third aspects of the present invention or for carrying out a use according to the fourth aspect of the present invention.

According to a sixth aspect of the present invention there is provided a program for controlling an apparatus to perform a method according to any one of the first to third aspects of the present invention, or for carrying out a use according to the fourth aspect of the present invention, or which, when loaded into an apparatus, causes the apparatus to become an apparatus according to the fifth aspect of the present invention. The program may be carried on a carrier medium. The carrier medium may be a storage medium. The carrier medium may be a transmission medium.

According to a sixth aspect of the present invention there is provided an apparatus programmed by a program according to the fifth aspect of the present invention.

According to a seventh aspect of the present invention there is provided a storage medium containing a program according to the fifth aspect of the present invention.

### BRIEF DESCRIPTION OF THE DRAWINGS

FIG. 1, discussed hereinbefore, illustrates schematically the integration of an IP Multimedia Subsystem into a 3G mobile communications system;

FIG. 2 is a block diagram for use in illustrating a first example embodying the present invention;

FIG. 3 is a block diagram for use in illustrating a second example embodying the present invention;

FIG. 4 is a block diagram for use in illustrating a third example embodying the present invention; and

FIGS. 5 and 6 are block diagrams for use in illustrating a fourth example embodying the present invention.

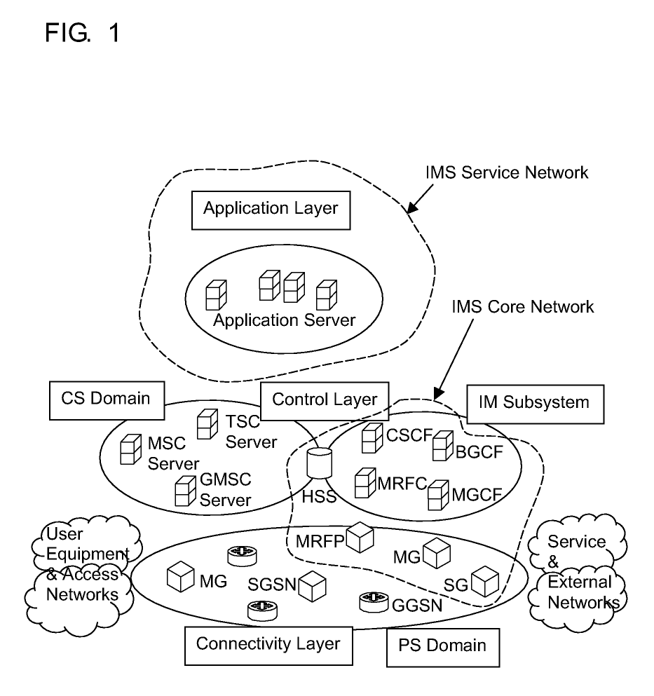

### DETAILED DESCRIPTION

According to an embodiment of the present invention, distribution of node status amongst the nodes of a group is achieved as follows:
1. A “Node Status SIP URI” is defined.
2. This Node Status SIP URI is shared amongst all nodes in the group.
3. Each node sends a SIP request with its status to the Node Status SIP URI, and this information is made available to all other nodes in the group.

In this way, a Node Status SIP URI is created and shared amongst the nodes in order to use as the Request URI when sending Node Status information. An example Node Status SIP URI might be “sip:nodestatus@operator.com”. Only a single Node Status SIP URI for those nodes that are sharing status information need be created. In a network, it may be possible to have different subgroups sharing status information, and hence only a single Node Status SIP URI per subgroup need be created. Another alternative is to use a single Node Status SIP URI per node, providing for a more granular distribution of data; in this case it might be that only those nodes that are interested in information from a particular node are included in a trigger relating to that information.

The Node Status SIP URI is shared amongst the nodes involved in sharing Node Status information, both for posting as well as for receiving. The details of how this is achieved are not important in relation to the present invention, but sharing could be achieved, for example, by provisioning or configuration.

It is not important what SIP request is used for sending status information, but one possibility is the SIP PUBLISH request, or potentially the SIP MESSAGE request.

The benefit of the SIP PUBLISH request is the “time to live” function it has, where it is possible to use the fact that a publication times out to draw a conclusion that the node is malfunctioning.

As described in the following description, there are several alternatives to update and distribute node status information in the network.

The node status information that is to be sent can differ depending on the need and also on when the node status is updated. For example, one possibility is that the node publishes information continuously, and as long as the node is functioning the publication is refreshed with quite high frequency. If the publication times out, the receiving node knows that the node has started to malfunction and can either draw conclusions directly from that information or query the node to make sure that the information is correct. The reporting node can, alternatively or in addition, send status information when a status change has occurred, such as the node has restarted. In this case, the receiving node knows that this node may have lost important information, such as existing sessions.

Examples of node status information in different situations are: “Node was restarted at time X; all SIP dialogs routed via the following SIP addresses before time X are lost”; “Node has been running since time Y when all SIP dialogs routed via the following SIP addresses were lost”; and “Node will be stopping at time Z, and all SIP dialogs routed before time Z via the following SIP addresses will be cleared ungracefully”.

It is possible that a node is tasked with storing the node status relating to all nodes identified by the Node Status URI. In this way, this information is kept in a central location, so that it is not necessary, for example, for a node to subscribe to different nodes to obtain the information. The Node Status URI “sip:nodestatus@operator.com” can therefore be considered as a virtual node that has the node status for all nodes in the group.

In general, therefore, a method of distributing node status information is proposed in which node status information is provided in a SIP Request whose Request Uniform Resource Identifier (Request-URI) enables a receiving node to determine that the SIP Request relates to or comprises node status information and/or identifies the intended recipients of the node status information.

If a SIP PUBLISH Request is used with a certain event package, then that package could serve the purpose at the receiving node of identifying the SIP Request as containing node status information, but even in that case the Request URI could still be used to identify the SIP request as containing node status information. However, if a SIP PUBLISH Request is used with event package “presence” or if a SIP MESSAGE Request is used, then the “Node Status URI” would be the means to find the correct software in the node to handle the Request.

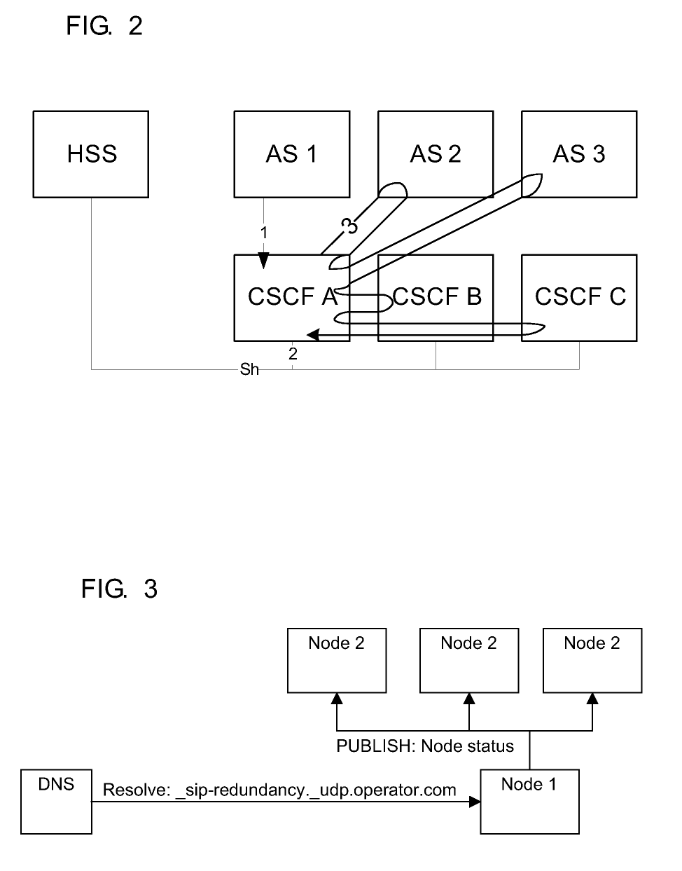

A first specific example will now be described with reference to FIG. 2. The first example is based on HSS triggers.

In this example, the Node Status SIP URI is stored in a HSS in a similar manner as a normal Public User Identifier or Public Service Identifier. A trigger (such as an IFC, or Initial Filter Criteria) is associated with the Node Status SIP URI. The trigger includes addresses for all nodes that want to receive status information.

In the example shown in FIG. 2, node AS1 sends status information in step 1 with a SIP request sent to CSCF A and addressed to “sip:nodestatus@operator.com”. On receipt, CSCF A reads the trigger information (step 2) for that user and event package, and distributes the request to all nodes included in the trigger (step 3). In this example, the interested nodes are AS2, AS3, CSCF A, CSCF B, CSCF C.

In order to distinguish this traffic from other SIP traffic, a new Event Package is proposed.

There are several reasons why this node status information is useful:
As a heart beat between nodes.
To inform that a node is back (from restart).
To inform about a new node introduced.

The body of the SIP request for the status message can contain additional information such as: “This node has been restarted, please take needed action”; “This is the first time this node send out status information” (tells the other nodes that there is a new node); and so on. This information can be expanded based on the needs of restoration procedures etc.

A second example will now be described with reference to FIG. 3. The second example is based on a DNS approach. Instead of using a trigger stored in HSS as in the first example, the Node Status URI can be resolved by DNS to a number of nodes that are notified about a node status change.

In the example, the node that reports the changed node status resolves the Node Status URI; in the illustration of FIG. 3 this is Node 1. One way to do this is to use a SRV query such as “_sip-redundancy._udp.operator.com” to receive a number of nodes that are notified. Node 1 then uses a SIP PUBLISH request or a SIP MESSAGE request (or some other SIP request) to notify the other nodes (Nodes 2) about the status.

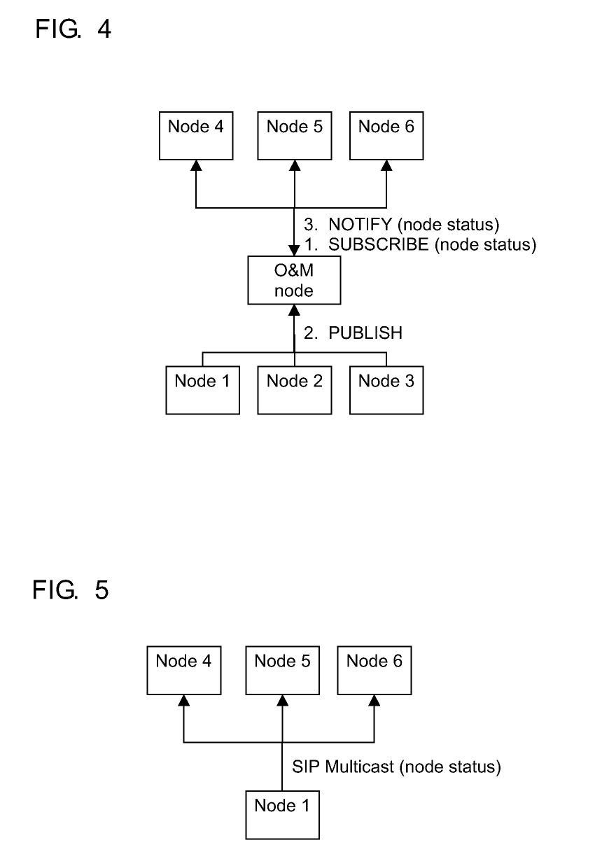

A third example will now be described with reference to FIG. 4. The third example is based on a SIP SUBSCRIBE approach.

In this example, the nodes that are interested in other nodes' status will use a SIP SUBSCRIBE request to request to be notified when any changes occur. The subscription request is made towards a central O&M node using, for example, “sip:nodestatus@operator.com”. This central node keeps track of the node status of different nodes, with the various nodes making the information available via, for example, a SIP PUBLISH request. This way of supplying information is similar to the standard way of using Presence in SIP.

The steps shown in FIG. 4 are summarised below:
1. A node that wants to receive node status updates sends a SIP SUBSCRIBE request to the O&M node using the “sip:nodestatus@operator.com” URI.
2. The node that wants to update its node status sends e.g. a SIP PUBLISH request or a SIP MESSAGE request to the O&M node using the “sip:nodestatus@operator.com” URI with up-to-date information.
3. When a change is detected by the O&M node, the O&M node will send a SIP NOTIFY request to all “watchers” that are interested in the node status information.

Note that it would be possible for the watching node to include a filter to inform the O&M node as to what nodes it is interested in, and possibly also what type of information (such as “node restart”), and at which occasions the notification is to be sent.

As mentioned previously, an advantage of using SIP PUBLISH is that the publication times out and the O&M node can then be aware of the fact that a timed-out publication means that a node may be malfunctioning. The O&M node could in this case also query the node to get the latest status or to check whether the node is actually down.

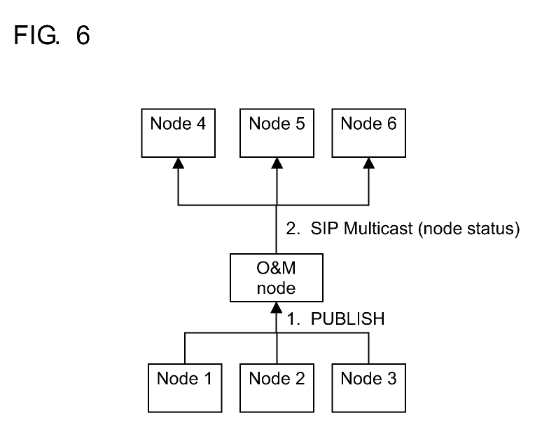

A fourth example will now be described with reference to FIGS. 5 and 6. The fourth example is a multicast-based approach.

A multicast approach can either be used in a situation where the reporting node uses the SIP Multicast address to inform all nodes with an interest in node status, or it can be an O&M server (as in the third example described above) that uses the SIP Multicast to inform other nodes about node status.

FIG. 5 illustrates the case where Node 1 uses the SIP Multicast to send a node status message to all other nodes listening to the multicast address. The Node Status URI is used at the receiving node to differentiate this SIP message from other SIP messages sent using multicast. This means that the receiving node uses the Request URI to determine that the SIP message is a “Node Status message”. In effect, the “Node Status function” in the node can be addressed by using this Node Status URI. Each node decides if the information is used or not.

Advantages of this solution compared to other solutions are that just one message is sent, and no central node is needed. One disadvantage (which can be avoided with using e.g. Subscribe with filters) is that the receiving node has to check the message to see if it is of any interest.

A variant is then to use a central node, where the node is updated using any appropriate method such as the SIP PUBLISH method, but then the central node uses SIP Multicast to inform all other nodes about changed node status. This is illustrated in FIG. 6.

Note that this alternative can be combined with the SUBSCRIBE based solution so that the O&M node supports both subscriptions as well as uses Multicast.

A fifth example will now be described. The fifth example uses a subscription-based distributed monitoring approach.

In this example, a SIP PUBLISH request or SIP MESSAGE request (or other type of request) is used to inform other nodes about the existence of a node, the status of it and future status changes. These can be monitored by subscribing to the status of the node directly using the SIP SUBSCRIBE/NOTIFY method to transport the detailed status information.

In this way, each node is effectively acting as its own “NodeStatus Notifier” Server, and the SIP PUBLISH/MESSAGE request is mainly used to inform the SIP address to a node that can be monitored. The method used to distribute this message can be any of the methods described above in the above-described HSS trigger based approach (first example), subscribe based approach (third example) and multicast based approach (fourth example). The SIP address to a node to monitor can also be obtained by a node by other means like configuration or by extracting the SIP address to nodes of interest from the SIP signalling passing the node and then via try and error found out if the node can act as a “NodeStatus” Notifier.

With an embodiment of the present invention, existing IMS mechanisms are used to achieve a smooth distribution of node status information. This can then be used for example by restoration procedures and so on.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

It will also be appreciated by the person of skill in the art that various modifications may be made to the above-described embodiments without departing from the scope of the present invention as defined by the appended claims. In particular, it will be appreciated that, although described in relation to a Universal Mobile Telecommunications System having an IP Multimedia Subsystem, the present invention is also applicable to other types of network.

What is claimed is:

1. A method for use in a telecommunications network that makes use of the Session Initiation Protocol the method comprising the step of:
receiving node status information in a SIP Request whose Request Uniform Resource Identifier (Request-URI), identifies the SIP Request as comprising node status information and also identifies the intended recipients of the node status information.

2. A method as claimed in claim 1, further comprising the step of determining the intended recipients from the received Request URI.

3. A method as claimed in claim 2, further comprising the step of forwarding the status information to the determined recipients.

4. A method as claimed in claim 2, further comprising the step of using the status information at the receiving node if the receiving node is determined to be one of the intended recipients.

5. A method as claimed in claim 2, further comprising the step of referring to an Initial Filter Criteria associated with the Request URI to determine the intended recipients.

6. A method as claimed in claim 2, further comprising the step of referring to a Dynamic Name Server to determine the intended recipients from the Request URI.

7. A method as claimed in claim 2, further comprising the step of determining the intended recipients in dependence upon a previously-received SIP SUBSCRIBE Request.

8. A method as claimed in claim 1, wherein the SIP Request is a SIP PUBLISH Request.

9. A method as claimed in claim 8, further comprising the step of using the time to live information from the SIP PUBLISH Request to infer further information about the node status.

10. A method as claimed in claim 1, wherein the SIP Request is a SIP MESSAGE request.

11. A method as claimed in claim 1, further comprising the step of storing the node status relating to those nodes identified by the SIP Request URI.

12. A method as claimed in claim 1, wherein the network is a Universal Mobile Telecommunications System comprising an IP Multimedia Subsystem, IMS.

13. A method for use in a telecommunications network that makes use of the Session Initiation Protocol (SIP), the method comprising the step of:
sending node status information in a SIP Request whose Request Uniform Resource Identifier (Request-URI), identifies the SIP Request as comprising node status information and also identifies the intended recipients of the node status information.

14. A method for use in a telecommunications network that makes use of the Session Initiation Protocol (SIP), the method comprising the step of:
sharing a Node Status SIP URI amongst a group of nodes, the Node Status SIP URI being for use subsequently by a node of the group as the Request Uniform Resource Identifier (Request-URI) in a SIP Request when sending node status information to other nodes in the group.

15. A method for use in a telecommunications network, comprising the step of using a Session Initiation Protocol (SIP) Request Uniform Resource Identifier, (Request-URI), in a telecommunications network to identify the SIP Request as comprising node status information and/or to identify the intended recipients of the node status information.

16. An apparatus for use in a telecommunications network, the apparatus comprising means for
receiving node status information in a SIP Request whose Request Uniform Resource Identifier (Request-URI), identifies the SIP Request as comprising node status information and also identifies the intended recipients of the node status information.

17. A program for controlling an apparatus to receive node status information in a SIP Request whose Request Uniform Resource Identifier (Request-URI), identifies the SIP Request as comprising node status information and also identifies the intended recipients of the node status information

18. A computer program which, when loaded into a computer readable medium of an apparatus, causes the apparatus, when executed by a microprocessor therein, to receive node status information in a SIP Request whose Request Uniform Resource Identifier (Request-URI), identifies the SIP Request as comprising node status information and also identifies the intended recipients of the node status information

19.-23. (canceled)
